(19) United States
(12) Patent Application Publication
(10) Pub. No.: US 2013/0049443 A1
(43) Pub. Date: Feb. 28, 2013

(54) WHEEL FOR A MOTOR VEHICLE

(71) Applicants: Heiko HEß, Lauterecken (DE); Jörg Schnorr, Ludwigshafen (DE); Walter Rau, Mannheim (DE); Sven Wenigmann, Mannheim (DE)

(72) Inventors: Heiko HEß, Lauterecken (DE); Jörg Schnorr, Ludwigshafen (DE); Walter Rau, Mannheim (DE); Sven Wenigmann, Mannheim (DE)

(73) Assignee: BASF SE, Ludwigshafen (DE)

(21) Appl. No.: 13/592,573

(22) Filed: Aug. 23, 2012

Related U.S. Application Data
(60) Provisional application No. 61/527,626, filed on Aug. 26, 2011.

(51) Int. Cl. B60B 5/02

(52) U.S. Cl. 301/64.703

(57) ABSTRACT

The invention relates to a wheel for a motor vehicle, comprising a wheel body (3) with a rim tape (7) for receiving a tire and also a rim star (9) or a wheel disk, through-openings (13) for fastening means for fastening the wheel on a nave on the motor vehicle being formed in the rim star (9) or in the wheel disk. The wheel (1) is produced from a polymer material and at least one reinforcing element (29;33) is accommodated in the rim tape (7) for reinforcement.

The invention proceeds from a wheel for a motor vehicle, comprising a rim with a rim tape for receiving a tire and also a rim star or a wheel disk, through-openings for fastening means for fastening the wheel on a nave on the motor vehicle being formed in the rim star or in the wheel disk, the wheel being produced from a polymer material.

At present, wheels for motor vehicles are produced from metallic materials, usually from steel or aluminum. The wheel is generally fastened to a wheel mounting, usually a brake drum or brake disk, on the motor vehicle by spherical-head screws or conical-head screws. As a result, the wheel is pressed against the mounting and the force transmission from the vehicle drive to the wheel is brought about by friction between the wheel and the area of contact of the wheel on the wheel mounting.

To reduce the fuel consumption of the motor vehicle, and consequently to save energy, it is intended to reduce the weight of the motor vehicle. For this purpose, it is endeavored, for example, to produce as many components of the motor vehicle as possible from materials of low weight, for example from plastics, and to replace the currently used metallic materials by plastics.

It is already known from DE-U 297 06 229 to produce wheels for a motor vehicle from a fiber-reinforced plastic. However, on account of the great forces that are transmitted to the wheel, the plastic of the wheel does have a tendency to creep, which can lead to deformation of the wheel. Even fiber reinforcement is generally not sufficient here to prevent the creep and the associated deformation. Moreover, too high a proportion of fibers, that would ensure sufficient strength with respect to the tendency to creep, has the effect that the material from which the rim is produced becomes too brittle, and consequently does not withstand the loads that occur during driving with the motor vehicle. This is manifested by cracks in the rim, for example, which may lead to rupturing.

A wheel made of a plastics material is likewise known from DE-A 42 23 290. Here, a compound synthetic resin wheel is joined together with two or more partial castings to form a single structural unit. Here, at least one of the partial castings comprises a thermally curing synthetic resin reinforced by means of long fibers, and the other partial casting comprises metal and/or a fiber-reinforced plastic. Here, it is generally the case that one of the partial castings is the rim tape or part of the rim tape, and the second partial casting is the rim star or the wheel disk. The separation of the rim tape and the wheel disk or rim star has the additional disadvantage that the forces acting on the wheel have to be transmitted at the connection site, in which case a weak point can be created by the additional connection.

It is an object of the present invention to provide a wheel for a motor vehicle which has a comparable construction to a construction based on a wheel made of a metallic material and has a sufficient stability for continuous operation of the motor vehicle.

The object is achieved by a wheel for a motor vehicle, comprising a rim with a rim tape for receiving a tire and also a rim star or a wheel disk, through-openings for fastening means for fastening the wheel on a nave on the motor vehicle being formed in the rim star or in the wheel disk, the wheel being produced from a polymer material and at least one reinforcing element being accommodated in the rim tape for reinforcement.

The reinforcing element in the rim tape additionally reinforces the actual rim of the wheel, and this results in a higher stability of the wheel produced from the polymer material. The reinforcing element in the rim tape prevents the wheel made of the polymer material from being damaged when the actual rim, comprising the inner and outer rim flanges, the hump, the rim shoulder and the rim well, is subjected to high loading. Such high loading of the actual rim occurs, for example, when a tire is pulled onto and filled on the wheel and furthermore during operation of the wheel, for example during driving as a result of potholes, when impact is made with the curbstone or in loading conditions such as crossing curbstones.

The at least one reinforcing element can be formed over the entire width of the rim tape. Alternatively, it is also possible to reinforce only regions subjected to particularly high loading using the at least one reinforcing element. It is thus possible, for example, for the region from the inner flange to the outer flange, including the rim well and the rim shoulder, to be reinforced or else for only individual regions between the inner and outer flanges and/or the outer flange and/or the inner flange to be reinforced by inlaid reinforcing elements.

According to the invention, a thermosetting or a thermoplastic material is used as the material for the wheel. This material may be used in a filled or unfilled state. With preference, however, filled polymers are used.

Suitable, for example, as polymers are natural and synthetic polymers or derivatives thereof, natural resins and synthetic resins and derivatives thereof, proteins, cellulose derivatives and the like. These may be—but do not have to be—chemically or physically curing, for example air-curing, radiation-curing or temperature-curing.

Apart from homopolymers, copolymers or polymer blends may also be used.

Preferred polymers are ABS (acrylonitrile-butadiene-styrene); ASA (acrylonitrile-styrene-acrylate); acrylated acrylates; alkyd resins; alkylene vinylacetates; alkylene-vinylacetate copolymers, particularly methylene vinylacetate, ethylene vinylacetate, butylene vinylacetate; alkylene-vinylchloride copolymers; amino resins; aldehyde and ketone resins; cellulose and cellulose derivatives, particularly hydroxyalkyl cellulose, cellulose esters, such as acetates, propionates, butyrates, carboxyalkyl celluloses, cellulose nitrates; epoxy acrylates; epoxy resins; modified epoxy resins, for example bifunctional or polyfunctional bisphenol-A or bisphenol-F resins, epoxy-novolak resins, bromated epoxy resins, cycloaliphatic epoxy resins; aliphatic epoxy resins, glycidyl ether, vinyl ether, ethylene-acrylic acid copolymers; hydrocarbon resins; MABS (transparent ABS comprising acrylate units); melamine resins; maleic acid-anhydride copolymers; (meth)acrylates; natural resins; colophony resins; shellac; phenolic resins; polyesters; polyester resins, such as phenylester resins; polysulfones (PSU); polyether sulfones (PESU); polyphenylene sulfone (PPSU); polyamides; polyimides; polyanilines; polypyrroles; polybutylene terephthalate (PBT); polycarbonates (for example Makrolon® from Bayer AG); polyester acrylates; polyether acrylates; polyethylene; polyethylene thiophenes; polyethylene naphthalates; polyethylene terephthalates (PET); polyethylene terephthalate glycol (PETG); polypropylene; polymethyl methacrylate (PMMA); polyphenylene oxide (PPO); polyoxymethylene (POM); polystyrenes (PS); polytetrafluoroethylene (PTFE); polytetrahydrofuran; polyether (for example polyethylene glycol, polypropylene glycol); polyvinyl compounds, particularly polyvinylchloride (PVC), PVC copolymers, PVdC, polyvinylacetate and copolymers thereof, optionally partially hydrolyzed polyvinyl alcohol, polyvinyl acetals, polyvinyl acetates, polyvinyl pyrrolidone, polyvinyl ether, polyvinyl acrylates and methacrylates in solution and as a dispersion as well as copolymers thereof, polyacrylates and polystyrene copolymers; polystyrene (toughened or non-toughened); polyurethanes, uncrosslinked or crosslinked with isocyanates; polyurethane acrylates; styrene acrylonitrile (SAN); styrene-acrylic copolymers; styrene-butadiene block copolymers (for example Styroflex® or Styrolux® from BASF SE, K-Resin™ from TPC); proteins, for example casein; SIS; triazine resin, bismaleimide-triazine resin (BT), cyanate ester resin (CE) or allylated polyphenylene ether (APPE). Furthermore, blends of two or more polymers may be used.

Particularly preferred polymers are acrylates, acrylate resins, cellulose derivatives, methacrylates, methacrylate resins, melamine and amino resins, polyalkylenes, polyimides, epoxy resins, modified epoxy resins, for example bifunctional or polyfunctional bisphenol-A or bisphenol-F resins, epoxy-novolak resins, bromated epoxy resins, cycloaliphatic epoxy resins; aliphatic epoxy resins, glycidyl ether, cyanate ester, vinyl ether, phenolic resins, polyimides, melamine resins and amino resins, polyurethanes, polyesters, polyvinyl acetals, polyvinyl acetates, polystyrenes, polystyrene copolymers, polystyrene acrylates, styrene-butadiene block copolymers, styrene-acrylonitrile copolymers, acrylonitrile-butadiene-styrene, acrylonitrile-styrene acrylate, polyoxymethylene, polysulfones, polyether sulfones, polyphenylene sulfone, polybutylene terephthalate, polycarbonates, alkylene vinylacetates and vinylchloride copolymers, polyamides, cellulose derivatives as well as copolymers thereof and blends of two or more of these polymers.

Particularly preferred polymers are polyamides, for example polyamide 4, polyamide 6, polyamide 7, polyamide 8, polyamide 9, polyamide 11, polyamide 12, polyamide 46, polyamide 66, polyamide 69, polyamide 610, polyamide 612, polyamide 613, polyamide 1212, polyamide 1313, polyamide 6T, polyamide 9T, polyamide MXD6, polyamide 6I, polyamide 6-3-T, polyamide 6/6T, polyamide 6/66, polyamide 6/12, polyamide 66/6/610, polyamide 6I/6T, polyamide PACM 12, polyamide 6I/6T/PACM, polyamide 12/MACMI, polyamide 12/MACMT or polyamide PDA-T, with preference polyamide 46, polyamide 6, polyamide 11, polyamide 12, polyamide 66, polyamide 66/6, polyamide 6/10 or polyamide 6/12 as well as partially aromatic polyamide, for example 6T/6, 6T/66, 6T/6I, polypropylene, polysulfones, polyether sulfones, polyphenylene sulfones, polybutylene terephthalate as well as blends thereof.

Customary additives may be admixed with the individual polymers, for example plasticizers, crosslinking agents, impact modifiers or flame retardants.

The polymer material is preferably reinforced. In particular, the polymer material is fiber-reinforced. Any fibers that are customary for reinforcement and are known to a person skilled in the art may be used for the reinforcement. Suitable fibers are, for example, glass fibers, carbon fibers, aramid fibers, boron fibers, basalt fibers, metal fibers, mineral fibers or potassium titanate fibers. The fibers may be used in the form of short fibers, long fibers or continuous fibers. The fibers may also be oriented or randomly arranged in the polymer material. In particular when continuous fibers are used, however, an oriented arrangement is usual. The fibers may in this case be used for example in the form of individual fibers, fiber strands, mats, woven or knitted structures or rovings. If the fibers are used in the form of continuous fibers, as rovings or as fiber mats, the fibers are usually placed in a mold and then encapsulated with the polymer material. The wheel body produced in this way may be a single-layered or multi-layered construction. In the case of a multi-layered construction, the fibers of the individual layers may in each case be directed in the same direction or the fibers of the individual layers are turned at an angle of −90° to +90° in relation to one another.

Within the context of the present invention, short fibers are understood to mean fibers having a length in the granules of less than 5 mm. Long fibers are fibers in granules having a length in the range of 5 to 30 mm, preferably in the range of 7 to 20 mm. By processing the granules, the long fibers are generally shortened, and therefore in the finished component these generally have a length which can range from in the region of 0.1 mm up to the maximum dimension of the granules which are used. In the case of customarily used granule sizes, the maximum length is in the range of up to 12 mm. In the case of granules having greater dimensions, the maximum length of the fibers can also lie above this value.

Long fibers are used with preference. If long fibers are used, they are usually admixed with the polymer compound before curing. The main body of the wheel body may be produced, for example, by extrusion, injection molding or casting. With preference, the entire wheel body is produced by injection molding or casting. The long fibers are generally randomly arranged in the wheel body. If the wheel body is produced by an injection molding process, the long fibers may be oriented by the polymer compound that comprises the fibers being forced through an injection nozzle into the mold. The proportion of the fibers in the polymer compound is preferably 30 to 70% by weight, in particular 45 to 65% by weight.

In a further embodiment, the polymer material comprises a mixture of short fibers and long fibers. In this case, the proportion of long fibers in the overall fiber proportion is preferably 5 to 95% by weight, and the proportion of short fibers is accordingly 95 to 5% by weight. With particular preference, the proportion of long fibers based on the overall fiber proportion is in the range of 15 to 85% by weight, and the proportion of short fibers is accordingly 85% to 15% by weight.

In addition to the fibers, the plastics material may also comprise any other fillers that are known to a person skilled in the art and have the effect of increasing stiffness and/or strength. These also include, inter alia, any desired particles without a preferential direction. Such particles are generally spherical, plate-shaped or cylindrical. The actual form of the particles may in this case deviate from the idealized form. Thus, spherical particles in particular may in reality also be for example droplet-shaped or flattened.

Apart from fibers, reinforcing materials that are used are, for example, graphite, chalk, talc and nanoscale fillers.

Glass fibers or carbon fibers are used with particular preference for reinforcement. Glass-fiber-reinforced polyamides are particularly preferred as the material for producing the rim.

If polyamides are used for reinforcement, it is possible to produce the rim by a so-called polyamide RIM process. To this end, continuous fibers are placed in a mold and impregnated with a monomer solution. Then, the monomer solution is cured to form the polymer.

In one embodiment of the invention, the rim tape is reinforced by reinforcing elements in the form of cords, which are accommodated in the circumferential direction in the rim tape. In this respect, it is possible to provide in each case individual cords in the length of the rim circumference and to inlay a plurality of cords in parallel as reinforcement. Alternatively, it is also possible to use one cord and to inlay it spirally in that region of the rim tape which is to be reinforced.

Within the context of the present invention, the term “cord” is to be understood to mean an elongate, pliant, resilient element which consists of twisted-together fibers or wires and is intended to transmit tensile forces.

In order to obtain easier handling, it is furthermore also possible to firstly form the reinforcing elements by connecting cords to one another to form a woven fabric with filaments oriented in the axial direction, for example. These woven fabrics can then easily be inserted into the mold for producing the wheel. A further alternative for connecting the cords to one another is to envelop these with a polymer compound. In this respect, it is also possible to impregnate the cords with a monomer mass, for example, to bring them to the shape of the wheel, such that the cords can then be inserted into the mold for producing the wheel, and then to cure the polymer material. As a result of the curing of the polymer material, the cords assume the desired shape.

Suitable as the material from which the cords are produced are, for example, metals such as steel, titanium or aluminum; aramid, carbon, glass, cellulose, basalt, mineral, boron, potassium titanate or plastic or a combination thereof.

With particular preference, metals, glass, carbon or aramid are used for the cords.

If plastics are selected as the material for the cords, polyamides, polyolefins, liquid crystalline polyesters (LCP) and ultra-high molecular weight polyethylenes (UHMW-PE) are suitable in particular.

In an alternative embodiment, the reinforcing element is an insert matched to the shape of the rim tape. The width of such an insert is selected on the basis of the desired width over which the reinforcement is intended to extend. Furthermore, it is also possible to match an appropriate insert to the cross-sectional geometry or parts of the cross-sectional geometry of the rim tape. In this case, an insert appropriately matched to the geometry of the rim is inserted into the rim for reinforcement during production and then encapsulated by injection molding with the polymer material for producing the wheel.

Metal sheets or organosheets can be used, for example, as inserts used for reinforcement. It is also possible to use rings made of a metal, a reinforced polymer or a ceramic as the insert for reinforcing the rim of the wheel.

If the insert is a metal sheet, the latter is preferably cut to the desired width and given a length which corresponds to the desired extent of the required insert. The metal sheet is then shaped to form a ring and optionally matched to the cross-sectional geometry of the rim tape.

If an organosheet is to be used for reinforcement, it is firstly possible to use already cured organosheets and to bring these to the desired shape in the presence of heat; alternatively, it is also possible to use semifinished products for reinforcement which cure to form the finished organosheet during the process for producing the wheel.

Within the context of the present invention, organosheets are understood to mean fiber-reinforced, planar polymer parts. The fiber reinforcement is provided here by continuous fibers. The fibers may be present here in the form of laid scrim fabrics, woven fabrics, loop-formingly knit fabrics, loop-drawingly knit fabrics or braided fabrics with a one-dimensional, two-dimensional or three-dimensional arrangement of the fibers. In this context, a one-dimensional classification means that the individual continuous fibers are oriented parallel to one another. A two-dimensional arrangement means that fibers are oriented parallel to one another in a first direction and fibers are oriented in a second direction turned with respect to the first direction. Here, the fibers are preferably turned at an angle of 45° to 90°, in particular of 90°, in relation to one another, in which case an angle of 90° also includes small deviations which may arise as a result of the laying of the fibers. In a three-dimensional arrangement, fibers are additionally also present extending with a part perpendicularly to the other fiber directions.

The fibers are then encapsulated with a thermoplastic or thermosetting polymer matrix. If a thermoplastic polymer is used, it is possible to still shape the organosheets after the polymer material has cured by heating and then shaping said organosheets. If a thermosetting polymer matrix is used, it is necessary to produce the organosheet already in the desired shape, since subsequent forming is no longer possible.

To produce semifinished products for the organosheets, it is furthermore advantageous to impregnate the fibers with a monomer solution and to cure the monomer solution only in subsequent process steps. In this respect, it is possible to carry out precrosslinking in order to obtain a first connection of the individual fibers.

If an insert made of a plastic is intended to be used for reinforcement, this can be produced, for example, by an injection molding process, an injection-compression molding process, by blow molding or by a polyamide RIM process. In the case of the polyamide RIM process, a monomer solution is introduced into a mold and cured in the mold.

It is furthermore preferred, if a plastic is used as the material for the insert which is used as the reinforcing element, to likewise reinforce the plastic. In this respect, it is possible to use short fibers, long fibers or continuous fibers. It is particularly preferred to use long fibers or continuous fibers for reinforcing the plastic for the insert.

If rings placed in the rim tape are used for reinforcement, these can be produced from a metal, a reinforced polymer, an organosheet or a ceramic. In this context, in contrast to an organosheet, a reinforced polymer is understood to mean a polymer reinforced with short fibers or with long fibers.

If use is made of rings made of a metal, these can be shaped from a metal sheet by bending, for example. Alternatively, it is also possible to cast or to forge the rings, for example. If use is to be made of rings made of a ceramic, these are usually produced by casting and subsequent firing. If the insert comprises rings made of a reinforced polymer, it is possible, for example, to produce the rings in a winding process, for example by thermoset winding, wet winding or thermoplastic winding, in a tape laying process, for example thermoset tape laying or thermoplastic tape laying, in a polyamide RIM process, in a pressing process, in an injection molding process, in an injection-compression molding process, in an extrusion process, in a resin infusion process, in a resin injection process or by blow molding.

In a further embodiment, the insert comprises rings made of a polymer reinforced with continuous fibers, the rings being produced in a weaving process, in a knitting process, in a braiding process or in a fiber deposition process, for example tailored fiber placement, and a subsequent resin infusion process or in a subsequent resin injection process or in a subsequent polyamide RIM process.

With particular preference, metals are used as the material for the insert or the rings. Suitable metals are, for example, steel, titanium, aluminum or magnesium.

To mount the wheel on the nave on the motor vehicle, it is furthermore preferred if the through-openings are reinforced. The through-opening can be reinforced, for example, in that the through-openings for receiving fastening means each receive a sleeve which is made of a metal or a ceramic and is connected positively to the polymer material of the wheel. The sleeves avoid the situation where the wheel begins to creep in the region of the through-openings on account of the high acting forces and as a result is deformed.

The sleeve used for stability in a through-opening is preferably connected positively to the polymer material of the wheel. The positive connection of the sleeve made of the metal or the ceramic is achieved in that, during the production of the wheel, firstly the sleeves are placed in a mold and then the sleeves are encapsulated by injection molding with the polymer material for the wheel body.

Aluminum, titanium or magnesium are suitable, for example, as the metal for the sleeves, it also being possible for the metals to be present as mixtures or in the form of alloys. If iron is used, it is preferably in the form of steel. Alternatively, the sleeves may also be produced as cast-iron parts, in which case the iron may be used both in the form of cast steel and gray cast iron.

Suitable ceramics from which the sleeves can be produced are, for example, ceramics based on aluminum oxide or silicon oxide.

As an alternative to the use of sleeves which are received in the through-holes for receiving fastening means, it is also possible to provide an adapter, which is connected to the rim star or the wheel disk in the region of the nave, the adapter having protuberances which engage in depressions in the region of the rim star or the wheel disk. The wheel is then fastened to an axle of the motor vehicle with the adapter. The adapter can be formed in one part with the wheel mounting on the vehicle axle or can be a separate part, in which case the adapter can be formed in one part with the wheel and has at least one area which is in contact with the wheel mounting on the vehicle axle. The adapter can be produced from the same metals as described above for the sleeves. Alternatively, it is also possible to produce the adapter from a ceramic.

For force transmission, the adapter has protuberances which engage in depressions in the rim star or in the wheel disk. As a result of the protuberances, which engage in depressions on the wheel, no force is transmitted directly to the wheel by friction and the deformation of the wheel caused by creep in the region of the fastening means is reduced to the extent that it is no longer harmful to the functioning of the wheel.

The wheel is preferably produced by an injection molding process or casting process, the material for the reinforcing elements being placed in the mold respectively before the polymer material is injected or poured in.

Examples of the invention are illustrated in the figures and are explained in more detail in the description which follows.

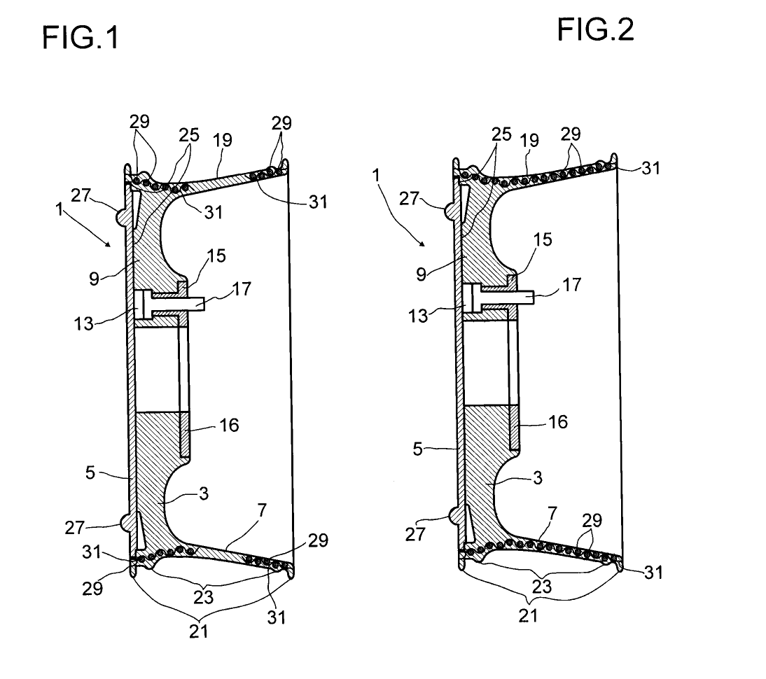

FIG. 1 shows a section through a wheel of a motor vehicle with reinforcement of the rim tape in a first embodiment,

FIG. 2 shows a section through a wheel of a motor vehicle with reinforcement of the rim tape in a second embodiment,

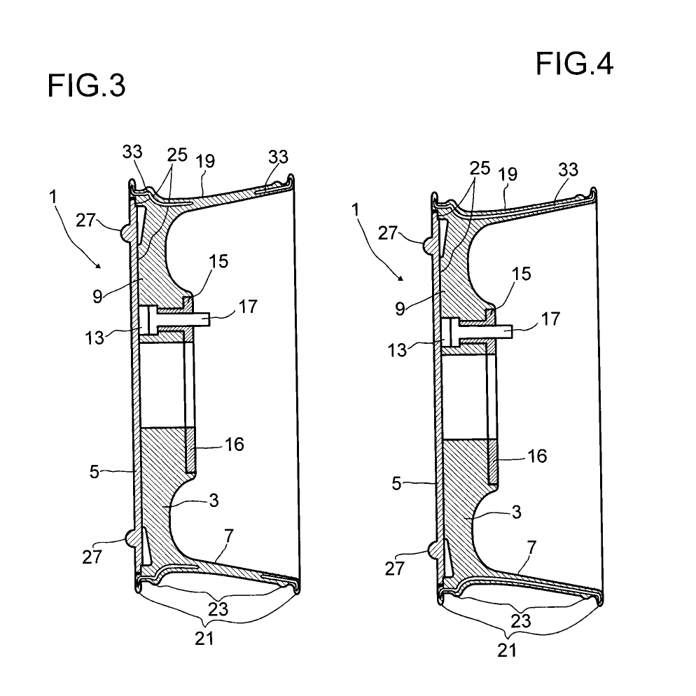

FIG. 3 shows a section through a wheel of a motor vehicle with reinforcement of the rim tape in a third embodiment,

FIG. 4 shows a section through a wheel of a motor vehicle with reinforcement of the rim tape in a fourth embodiment.

FIG. 1 shows a wheel of a motor vehicle with reinforcement of the rim tape in a first embodiment.

In the embodiment shown here, a wheel 1 for a motor vehicle comprises a wheel body 3 and a cap 5. In an alternative embodiment, however, it is also possible for the wheel 1 to comprise only the wheel body 3 and to have no cap. Furthermore, a cap may also be provided on each side of the wheel body 3.

According to the invention, the wheel body 3 is produced from a polymer material. In order to obtain a sufficiently great stability of the wheel body 3, the polymer material is preferably reinforced. Fibers in the form of short fibers, long fibers or continuous fibers can be used for reinforcement. The use of long fibers is preferred. Thermoplastic or thermosetting polymers as described above are suitable as the polymer material for the wheel body 3.

The wheel body 3 comprises a rim tape 7 for receiving a tire and a rim star 9. Through-holes 13 are made in the rim star 9, through which through-holes it is possible to guide fastening means for fastening the wheel body 3 on a vehicle axle, usually on a brake drum or brake disk.

With preference, the through-hole 13 preferably receives a sleeve 15. The sleeve 15 serves for additional stabilization in the region of the through-hole 13, in order to avoid damage to the wheel body 3 as a result of the inserted fastening means. The sleeve is usually produced from a metal or a ceramic and is preferably cast during the production of the wheel body 3, such that the sleeve 15 is connected positively to the wheel body 3. In addition to the sleeve 15, it is also possible to provide an insert 16, which forms a contact surface for the assembly of the wheel 1. In this case, it is possible to provide the insert 16 and the sleeves 15 as separate components or to form the sleeves 15 in one piece with the insert 16.

In order to fasten the wheel body 3 to the vehicle axle, wheel bolts 17 are used as suitable fastening means, for example. The wheel bolts 17 allow the wheel body 3 to be detachably connected to the vehicle axle, such that the wheel can easily be disassembled, for example if the wheel is damaged or if it is necessary to change the tire.

The rim tape 7 usually comprises an outer rim well 19. At its outer edges, the outer rim well 19 is terminated by a rim flange 21. The rim flange 21 serves for the mounting of a tire which has been pulled onto the wheel 1. In this respect, the tire is pressed against the rim flange 21 with its outer side.

If a tubeless tire is used, it is furthermore necessary to avoid inward displacement of the tire as a result of the pressure exerted during driving. To this end, the outer rim well 19 has so-called humps 23. The side wall of the pulled-on tire is thus held between the rim flange 21 and the hump 23, the hump 23 bearing against the inner side of the tire wall.

If a cap 5 is provided, it can be used for additionally stabilizing the wheel 1 and alternatively or additionally also as a design element. To this end, it is possible to form the cap in any desired shape. If the cap 5 is designed appropriately, it is furthermore also possible for said cap to be used for improving the aerodynamics of the motor vehicle.

If a cap 5 is used, it can be connected non-positively, positively or integrally to the wheel body 3. In the embodiment shown here, the cap 5 is connected positively to the wheel body 3.

Possible positive connections between the cap 5 and the wheel body 3 are, for example, adhesive bonding or welding. Suitable non-positive connections are, for example, screw connections, rivet connections or connections by clips.

In order to obtain a sufficient stability of the rim tape 7, the rim tape 7 is reinforced according to the invention. In the embodiment shown in FIG. 1, cords 29 are placed in the rim tape 7 for reinforcement in the rim tape 7 in each case in the region of the rim flanges 21 and of the humps 23. The cords 29 here can be interwoven with filaments 31 and thereby form a woven structure.

Suitable materials for the cords are, for example, metals, for example aluminum, titanium, iron, in particular steel, aramid, glass, basalt, carbon, boron, potassium titanate, mineral, cellulose or polymers with a higher strength than the polymer from which the rim tape 7 is produced. Polymers from which the cords for reinforcement can be produced are, for example, polyamides, polyolefins, liquid crystalline polyesters (LCP) and ultra-high molecular weight polyethylenes (UHMW-PE).

With particular preference, cords 29 made of a metal, in particular steel cords, are used for reinforcement.

Any desired material from which filaments can be produced is suitable as the material for the filaments 31 for weaving the cords 29. Suitable materials are, for example, synthetic fibers, for example of polyamide, of polyester, of polypropylene, of viscose or of polyethylene, or else natural fibers such as wool, cellulose or cotton. Furthermore, it is also possible to use a metal as the material for the filament 31.

In the embodiment shown in FIG. 1, the rim tape 7 is reinforced only in the region of the rim flanges 21 and of the humps 23. The rim tape 7 is not reinforced in the central region. Here, the reinforcement serves to reinforce the rim tape 7 at the support region of a tire, which is pulled onto the rim tape 7.

FIG. 2 shows a wheel 1 for a motor vehicle in a second embodiment.

In contrast to the embodiment shown in FIG. 1, the reinforcement of the rim tape 7 is not interrupted in the embodiment shown in FIG. 2, but instead the entire rim tape 7 is reinforced over the entire axial width. Reinforcement is likewise provided by using cords 29, which can optionally be interwoven with filaments 31 to form a woven structure.

A further embodiment for a motor vehicle wheel is shown in FIG. 3.

In the embodiment shown in FIG. 3, it is likewise only the region of the rim flanges 21 and of the humps 23 in which the tire rests on the rim tape 7 which is reinforced. In contrast to the embodiment shown in FIG. 1, however, the reinforcement in the embodiment shown in FIG. 3 is not provided by cords running in the circumferential direction in the rim tape 7, but instead by annular reinforcing elements 33. The annular reinforcing element 33 here can be adapted to the contour of the rim tape 7.

A suitable material for the annular reinforcing element 33 is, for example, a metal, for example aluminum, titanium or iron, for example steel, or an organosheet is used. In this case, an organosheet is understood to mean a polymer material reinforced with continuous fibers.

In the embodiment shown in FIG. 4, the rim tape is likewise reinforced by an annular reinforcing element 33; in the embodiment shown in FIG. 4, the annular reinforcing element 33 extends over the entire axial width of the rim tape 7. In the embodiment shown in FIG. 4, too, the annular reinforcing element 33 is produced, for example, from a metal sheet or an organosheet. For reinforcement, it is preferable that here, too, the annular reinforcing element 33 is adapted to the contour of the outer rim well 19.

As an alternative to an annular reinforcing element 33 made of a metal or an organosheet, it is also possible to design the annular reinforcing element 33 as a ring made of a reinforced polymer or a ceramic. In this case, in contrast to an organosheet, a reinforced polymer is understood to mean a polymer reinforced with short fibers or with long fibers. In order to reinforce the rim tape 7, the reinforced polymer material from which the annular reinforcing element 33 is produced in this case has a higher strength than the polymer material from which the rim tape 7 is produced.

In all of the embodiments shown in FIGS. 1 to 4, the cap 5 has a sacrificial rib 27. The sacrificial rib 27 serves to protect the wheel 1 against damage, for example caused by the wheel making contact with a curbstone. With preference, here the sacrificial rib 27 is arranged annularly around the axis of the wheel 1. As an alternative to the embodiments shown here, in which the sacrificial rib 27 is formed on the cap 5, it is also possible to form a sacrificial rib on the wheel body 3, for example in the region of the rim tape 7.

### LIST OF REFERENCE SIGNS

1 Wheel
3 Wheel body
5 Cap
7 Rim tape
9 Rim star
13 Through-hole
15 Sleeve
16 Insert
17 Wheel bolt
19 Outer rim well
21 Rim flange
23 Hump
25 Connection point
27 Sacrificial rib
29 Cord
31 Filament
33 Annular reinforcing element

1. A wheel for a motor vehicle, comprising a wheel body (3) with a rim tape (7) for receiving a tire and also a rim star (9) or a wheel disk, through-openings (13) for fastening means for fastening the wheel on a nave on the motor vehicle being formed in the rim star (9) or in the wheel disk, the wheel (1) being produced from a polymer material, wherein at least one reinforcing element (29;33) is accommodated in the rim tape (7) for reinforcement.

2. The wheel according to claim 1, wherein cords (29) are accommodated as reinforcing elements in the circumferential direction in the rim tape (7).

3. The wheel according to claim 2, wherein the material from which the cords (29) are produced is selected from steel, titanium, aluminum, aramid, carbon, glass, cellulose, basalt, mineral, boron, potassium titanate or plastic or a combination thereof.

4. The wheel according to claim 2, wherein the cords (29) are connected to one another to form a woven fabric with filaments (31) oriented in the axial direction.

5. The wheel according to claim 1, wherein the reinforcing element (33) is an insert matched to the shape of the rim tape (7).

6. The wheel according to claim 5, wherein the insert is a metal sheet or an organosheet or comprises rings made of a metal, a reinforced polymer or a ceramic.

7. The wheel according to claim 6, wherein the insert comprises rings made of a reinforced polymer, the rings being produced in a winding process, in a tape laying process, in a polyamide RIM process, in a pressing process, in an injection molding process, in an injection-compression molding process, in an extrusion process, in a resin infusion process, in a resin injection process or by blow molding.

8. The wheel according to claim 6, wherein the insert comprises rings made of a polymer reinforced with continuous fibers, the rings being produced in a weaving process, in a knitting process, in a braiding process or in a fiber deposition process and a subsequent resin infusion process or in a subsequent resin injection process or in a subsequent polyamide RIM process.

9. The wheel according to claim 6, wherein the metal of the metal sheet or of the rings is selected from steel, titanium, aluminum or magnesium.

10. The wheel according to claim 1, wherein the polymer material is selected from polybutylene terephthalate, polyethylene sulfone, polysulfone, polypropylene or polyamide.

11. The wheel according to claim 1, wherein the polymer material is reinforced.

12. The wheel according to claim 11, wherein short fibers, long fibers or continuous fibers are used for reinforcing the polymer material.

13. The wheel according to claim 12, wherein the fibers for reinforcing the polymer material are glass fibers, carbon fibers, aramid fibers, potassium titanate fibers, boron fibers, basalt fibers, mineral fibers or metal fibers.

14. The wheel according to claim 1, wherein the through-openings (13) for receiving fastening means (17) each receive a sleeve (15) which is made of a metal or a ceramic and is connected positively to the polymer material of the wheel body (3).
